(19) United States
(12) Patent Application Publication
(10) Pub. No.: US 2025/0370411 A1
(43) Pub. Date: Dec. 4, 2025

(54) TIMEPIECE

(71) Applicant: SEIKO WATCH KABUSHIKI KAISHA (trading as SEIKO WATCH CORPORATION), Tokyo (JP)

(72) Inventor: Tatsuyuki SUGIMOTO, Tokyo (JP)

(21) Appl. No.: 19/208,194

(22) Filed: May 14, 2025

(30) Foreign Application Priority Data
May 28, 2024 (JP) 2024-086212

(51) Int. Cl. G04B 13/02; G04B 19/06

(52) U.S. Cl. CPC G04B 13/02; G04B 19/06

(57) ABSTRACT

In a timepiece including an operation portion that rotates an inner rotating ring only in one direction while generating a click feeling, durability of components is improved. The timepiece includes a rotation operation portion having a second gear that rotates in synchronization with the inner rotating ring, and a rotation restriction member that restricts an operation of the rotation operation portion. The rotation restriction member includes an engagement portion engaged with an engagement tooth of the second gear so as to move to a first side in a movement direction by counterclockwise rotation of the second gear and move to a second side in the movement direction by clockwise rotation of the second gear, a restriction wall portion that allows the movement of the rotation restriction member, which is located at a restriction position, to the second side while restricting the movement of the rotation restriction member to the first side, and a biasing portion that biases the engagement portion to the first side in a state where the rotation restriction member is moved from the restriction position toward the second side to a biasing position. The engagement portion is configured to be disengaged from the engagement tooth of the second gear rotating clockwise in a state where the rotation restriction member is located at the biasing position.

### RELATED APPLICATIONS

This application claims priority to Japanese Patent application No. JP2024-086212, filed on May 28, 2024, the entire content of which is incorporated herein by reference.

### BACKGROUND OF THE INVENTION

### 1. Field of the Invention

The present invention relates to a timepiece.

### 2. Description of Related Art

A timepiece including an inner rotating ring rotatable along an outer peripheral edge of a dial is used (see, for example, JP2012-052919A). JP2012-052919A discloses a timepiece including: a rotatable operation member provided on a side portion of a wristwatch case so as to penetrate from an outside to an inside thereof; a gear provided on an inner end portion side of the operation member located in the wristwatch case and configured to rotate integrally with the operation member; a rotating ring provided in the wristwatch case so as to be rotatable along an inner peripheral surface thereof and configured to rotate in conjunction with rotation of the gear due to a rotation operation of the operation member; and a leaf spring-like elastic piece fixed to a case back and configured to elastically contact a tooth portion of the gear. In this timepiece, when the operation member is rotated, a rotational driving force is transmitted to the rotating ring, and the rotating ring rotates.

In the timepiece disclosed in JP2012-052919A, the gear and the elastic piece are formed such that the elastic piece is elastically deformed by the tooth portion of the gear when the operation member rotates in one direction to enable the operation member to rotate, and the elastic piece locks the tooth portion of the gear to prevent the rotation of the operation member when the operation member rotates in the other direction. Accordingly, when the operation member is rotated, the tooth portions of the gear sequentially ride over the elastic piece, and thus a click feeling is given to the operation member.

However, in the timepiece disclosed in JP2012-052919A, since the reverse rotation of the operation member is restricted by the elastic piece and a click feeling is given to the operation member by the elastic piece, a large load is applied to the elastic piece, and there is room for improvement in durability of the component.

### SUMMARY OF THE INVENTION

It is an aspect of the present application to improve durability of a component in a timepiece including an operation portion that rotates an inner rotating ring only in one direction while generating a click feeling.

A timepiece according to a first aspect of the application includes: a case; a dial accommodated in the case; an inner rotating ring formed in a ring shape along an outer peripheral edge of the dial and rotatable in a circumferential direction; a rotation operation portion including a head portion disposed outside the case, and an engagement gear provided to be synchronously rotatable with the inner rotating ring; and a rotation restriction member provided to be movable along a movement direction orthogonal to an axial direction of the rotation operation portion and configured to restrict an operation of the rotation operation portion. The rotation restriction member includes an engagement portion that engages with teeth of the engagement gear so as to allow the rotation restriction member to move to a first side in the movement direction by rotation of the engagement gear in a first rotation direction and move to a second side in the movement direction by rotation of the engagement gear in a second rotation direction, a restriction portion that restricts movement of the rotation restriction member, which is located at a restriction position, to the first side, and allows movement of the rotation restriction member to the second side, and a biasing portion that biases the engagement portion toward the first side in a state where the rotation restriction member is moved from the restriction position toward the second side to a biasing position. The engagement portion is configured to be disengaged from the teeth of the engagement gear rotating in the second rotation direction in a state where the rotation restriction member is at the biasing position.

According to the first aspect, when a torque in the first rotation direction is input to the rotation operation portion, the rotation restriction member moves to the first side to the restriction position. In a state where the rotation restriction member is located at the restriction position, the restriction portion restricts the movement of the rotation restriction member to the first side, and thus the rotation of the rotation operation portion in the first rotation direction is also restricted. Therefore, the rotation of the inner rotating ring in the first direction corresponding to the rotation of the rotation operation portion in the first rotation direction is prevented.

When the rotation restriction member is located at the restriction position, the movement of the rotation restriction member to the second side is allowed, and thus the rotation of the engagement gear in the second rotation direction is also allowed. Therefore, when a torque in the second rotation direction is input to the rotation operation portion, the rotation restriction member moves from the restriction position toward the second side to the biasing position. When the rotation restriction member is located at the biasing position, the engagement portion is biased to the first side by a biasing force of the biasing portion. When the rotation operation portion is rotated in the second rotation direction in this state, the rotation restriction member tends to move to the second side by the engagement between the teeth of the engagement gear and the engagement portion and tends to return to the first side by the biasing force of the biasing portion. Since the engagement portion can be disengaged from the teeth of the engagement gear rotating in the second rotation direction in a state where the rotation restriction member is located at the biasing position, when the rotation operation portion is continuously rotated in the second rotation direction, the rotation restriction member repeats movement to the second side and movement to the first side, and engagement and disengagement of the engagement portion with the teeth of the engagement gear are repeated. Accordingly, since the engagement portion repeatedly collides with the engagement gear and an impact in the first rotation direction is applied to the engagement gear, a click feeling is given to the rotation operation portion.

When the rotation operation portion rotates in the second rotation direction, the engagement and disengagement between the engagement gear and the engagement portion are repeated, so that the rotation operation portion can rotate in the second rotation direction without restriction. Therefore, when a torque in the second rotation direction is input to the rotation operation portion, the inner rotating ring rotates in a second direction corresponding to the rotation of the rotation operation portion in the second rotation direction.

As described above, it is possible to obtain a timepiece including the rotation operation portion capable of rotating the inner rotating ring only in the second direction while generating a click feeling. Since the restriction portion and the biasing portion are provided at different positions in the rotation restriction member, it is possible to avoid concentration of a load on only one specific position in the rotation restriction member. Therefore, the durability of components can be improved.

A timepiece according to a second aspect of the application is the timepiece according to the first aspect, in which the engagement gear may be engaged with an end portion of the engagement portion on the first side in a state where the rotation restriction member is located at the biasing position.

A timepiece according to a third aspect of the application is the timepiece according to the first aspect or the second aspect, in which the biasing portion may come into contact with the engagement gear and bias the engagement gear toward the second side in a state where the rotation restriction member is located at the biasing position.

A timepiece according to a fourth aspect of the application is the timepiece according to any one of the first aspect to the third aspect, in which the restriction portion may restrict the movement of the rotation restriction member, which is located at the restriction position, to the first side, by engaging with the rotation operation portion.

A timepiece according to a fifth aspect of the application is the timepiece according to the fourth aspect, in which the restriction portion may engage with the engagement gear.

A timepiece according to a sixth aspect of the application is the timepiece according to the fifth aspect, in which the engagement portion, the restriction portion, and the biasing portion may be located at a same position in the axial direction.

A timepiece according to a seventh aspect of the application is the timepiece according to any one of the first aspect to the sixth aspect, in which the biasing portion may include a locking protrusion that is locked to the engagement gear from a downstream side in the second rotation direction.

According to the application, it is possible to improve durability of a component in a timepiece including an operation portion that rotates an inner rotating ring only in one direction while generating a click feeling.

### BRIEF DESCRIPTION OF THE DRAWINGS

FIG. 1 is a cross-sectional view of a timepiece 1 according to an embodiment.

FIG. 2 is an enlarged view of a periphery of a rotation operation portion 7 in the cross section illustrated in FIG. 1.

FIG. 3 is a perspective view illustrating a main part of the timepiece 1 according to the embodiment.

FIG. 4 is a perspective view illustrating the rotation operation portion 7 and a rotation restriction member 8 according to the embodiment.

FIG. 5 is a diagram illustrating an operation of the timepiece 1 according to the embodiment.

FIG. 6 is a diagram illustrating an operation of the timepiece 1 according to the embodiment.

FIG. 7 is a diagram illustrating an operation of the timepiece 1 according to the embodiment.

FIG. 8 is a diagram illustrating an operation of the timepiece 1 according to the embodiment.

FIG. 9 is a diagram illustrating an operation of the timepiece 1 according to the embodiment.

FIG. 10 is a view of the rotation operation portion 7 and a rotation restriction member 9 according to a modification of the embodiment as viewed from an inner side in an axial direction.

### DETAILED DESCRIPTION OF THE PREFERRED EMBODIMENTS

Hereinafter, an embodiment of the invention will be described with reference to the drawings. In the following description, components having the same or similar functions are denoted by the same reference signs. A redundant description of the components may be omitted.

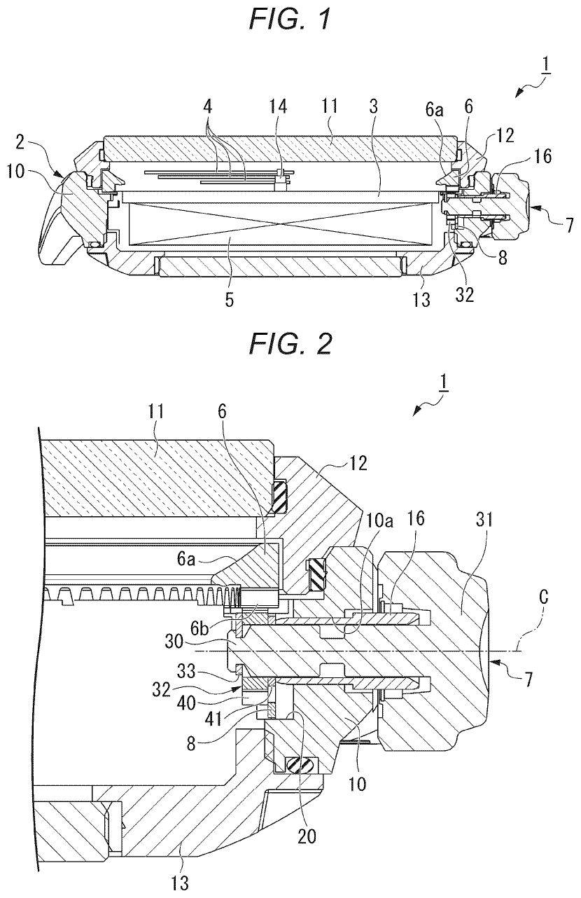

FIG. 1 is a cross-sectional view of a timepiece 1 according to an embodiment.

As illustrated in FIG. 1, the timepiece 1 according to the embodiment includes a timepiece case 2, a dial 3, hands 4, a movement 5, an inner rotating ring 6, a rotation operation portion 7, and a rotation restriction member 8.

The timepiece case 2 (case) includes a case main body 10, a windshield 11, a bezel 12, and a case back 13. The case main body 10 is formed in a cylindrical shape. The windshield 11 closes one opening of the case main body 10. The bezel 12 is provided at one opening end of the case main body 10. The bezel 12 holds the windshield 11. The case back 13 closes the other opening of the case main body 10. The timepiece case 2 accommodates the dial 3, the hands 4, and the movement 5. Hereinafter, in the embodiment, a rotation axis direction of the hand 4 is referred to as an up-down direction. In the up-down direction, a direction from the case back 13 toward the windshield 11 is described as an upper side, and an opposite side thereof is described as a lower side.

The dial 3 is formed in a circular plate shape. The dial 3 is visible through the windshield 11.

The hands 4 are disposed between the dial 3 and the windshield 11. The hands 4 are attached to a rotation shaft 14 of the movement 5. The movement 5 is disposed between the dial 3 and the case back 13. The movement 5 includes a drive source that drives the rotation shaft 14 and the like.

The inner rotating ring 6 is formed in an annular shape along an outer peripheral edge of the dial 3. The inner rotating ring 6 is formed in an annular shape centered on an axis extending in the up-down direction. The inner rotating ring 6 is rotatable in a first circumferential direction. The “first circumferential direction” is a direction around a central axis of the inner rotating ring 6. The central axis of the inner rotating ring 6 coincides with a center of the rotation shaft 14.

The inner rotating ring 6 includes an information display surface 6a. The information display surface 6a is a region including an inner peripheral edge of an upper surface of the inner rotating ring 6. The information display surface 6a is an inclined surface that descends inward in a main radial direction. The “main radial direction” is a direction orthogonal to the up-down direction and the first circumferential direction. Information display can be formed on the information display surface 6a by characters, symbols, graphics, or the like. In the embodiment, the inner rotating ring 6 is a reverse rotation prevention bezel provided in a so-called diver's watch or the like.

FIG. 2 is an enlarged view of a periphery of the rotation operation portion 7 in the cross section illustrated in FIG. 1.

As illustrated in FIG. 2, a plurality of tooth portions 6b arranged in the first circumferential direction are formed on a lower surface (a surface on the case back 13 side) of the inner rotating ring 6. The tooth portions 6b protrude downward from the lower surface of the inner rotating ring 6.

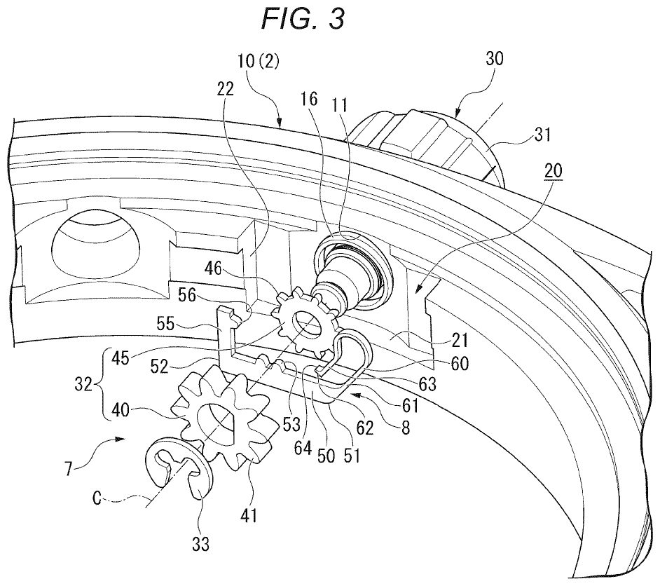

FIG. 3 is a perspective view illustrating a main part of the timepiece 1 according to the embodiment and illustrates a state in which the rotation operation portion 7 is exploded.

As illustrated in FIGS. 2 and 3, an operation hole 10a and a holding recess 20 are formed in the case main body 10. The operation hole 10a penetrates the case main body 10 along the main radial direction. A support tube 16 is provided in the operation hole 10a. The holding recess 20 is formed on an inner peripheral surface of the case main body 10 and is continuous with an end portion of the operation hole 10a on the inner side in the main radial direction. The holding recess 20 is formed below the inner rotating ring 6. The holding recess 20 includes a lower surface 21 facing upward and a pair of side surfaces 22 extending upward from both ends of the lower surface 21 in the first circumferential direction. The lower surface 21 is a flat surface orthogonal to the up-down direction. The side surface 22 is a flat surface extending in the up-down direction.

The rotation operation portion 7 includes a rotation shaft portion 30, a head portion 31, and a drive transmission gear 32.

The rotation shaft portion 30 is inserted into the support tube 16. The rotation shaft portion 30 is rotatable about an axis C along the main radial direction. A direction around the axis C of the rotation shaft portion 30 is referred to as a “second circumferential direction”. The axial direction of the rotation shaft portion 30 is simply referred to as an “axial direction”.

The head portion 31 is formed on an outer end portion of the rotation shaft portion 30. The head portion 31 is integrally formed with the rotation shaft portion 30. The head portion 31 has an outer diameter larger than an outer diameter of the rotation shaft portion 30. The head portion 31 is located outside the case main body 10 and is formed to be rotatable by a user. The head portion may be provided separately from the rotation shaft portion as long as the head portion is rotatable integrally with the rotation shaft portion.

The drive transmission gear 32 is disposed inside the case main body 10. The drive transmission gear 32 is provided so as to be integrally rotatable with the rotation shaft portion 30. The drive transmission gear 32 is attached to the rotation shaft portion 30 by an attachment member 33 such as a C ring such that relative rotation is disabled. The drive transmission gear 32 includes a first gear 40 and a second gear 45 (engagement gear).

The first gear 40 includes a plurality of drive teeth 41 arranged at equal intervals in the second circumferential direction. The drive teeth 41 mesh with the tooth portions 6b of the inner rotating ring 6. The first gear 40 transmits the rotation of the rotation operation portion 7 to the inner rotating ring 6 by meshing between the drive teeth 41 and the tooth portions 6b and rotates the inner rotating ring 6 in the first circumferential direction.

The second gear 45 is provided so as not to rotate relative to the first gear 40 and rotates in synchronization with the inner rotating ring 6. The second gear 45 is disposed of an outer side of the first gear 40. The second gear 45 is disposed at an inner side of the holding recess 20. The second gear 45 is formed to have a smaller diameter than the first gear 40. The second gear 45 includes a plurality of engagement teeth 46 arranged at equal intervals in the second circumferential direction. For example, the number of the engagement teeth 46 is the same as that of the drive teeth 41.

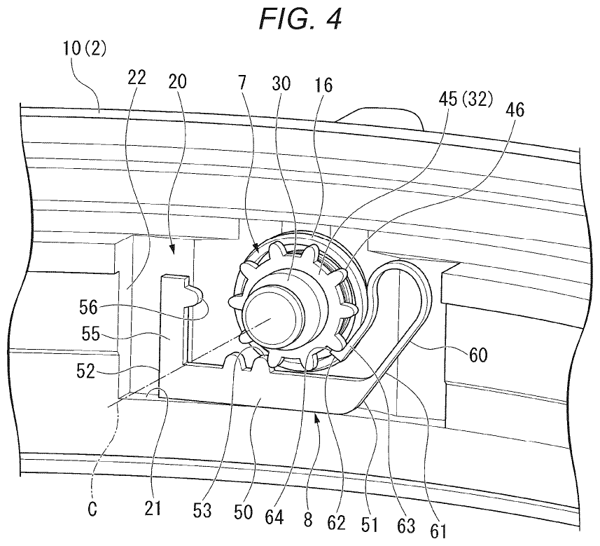

FIG. 4 is a perspective view illustrating the rotation operation portion 7 and the rotation restriction member 8 according to the embodiment and illustrates a state in which the first gear 40 and the attachment member 33 are removed.

As illustrated in FIG. 4, the rotation restriction member 8 is disposed inside the holding recess 20. The rotation restriction member 8 has a flat plate shape having a thickness in the axial direction. The rotation restriction member 8 includes a base portion 50, a restriction wall portion 55, and a biasing portion 60. The base portion 50, the restriction wall portion 55, and the biasing portion 60 are located at the same position in the axial direction.

The base portion 50 is disposed between the second gear 45 and the lower surface 21 of the holding recess 20. The base portion 50 is slidably disposed on the lower surface 21 of the holding recess 20. The rotation restriction member 8 is movable in a direction, which is orthogonal to the up-down direction and the axial direction, along the lower surface 21 of the holding recess 20. The direction orthogonal to the up-down direction and the axial direction is referred to as a “movement direction”. Of the movement direction, a direction corresponding to a clockwise direction when viewed from above is referred to as a first side, and an opposite side thereof is referred to as a second side. The base portion 50 has a length in the movement direction. The base portion 50 includes a first end portion 51 and a second end portion 52 in the movement direction, and an engagement portion 53 protruding upward from an upper edge of the base portion 50. The first end portion 51 is an end portion of the base portion 50 on the first side in the movement direction. The engagement portion 53 is provided between the first end portion 51 and the second end portion 52. The engagement portion 53 detachably meshes with the engagement tooth 46 of the second gear 45. In the illustrated example, two engagement portions 53 are arranged side by side in the movement direction. The second gear 45 and the base portion 50 form a rack-and-pinion mechanism by meshing of the engagement tooth 46 and the engagement portion 53. The base portion 50 moves to the second side in the movement direction when the second gear 45 is rotated clockwise as viewed from the inner side in the axial direction and moves to the first side in the movement direction when the second gear 45 is rotated counterclockwise. A position of an end portion of the engagement portion 53 on the first side in the movement direction is set to a position where the operation of the timepiece 1 described later can be implemented.

The restriction wall portion 55 is connected to the second end portion 52 of the base portion 50. The restriction wall portion 55 extends upward from the base portion 50. The restriction wall portion 55 overlaps the second gear 45 as viewed from the movement direction. The restriction wall portion 55 includes a restriction protrusion 56 protruding from an edge portion of the restriction wall portion 55 on a second gear 45 side to the second gear 45 side. The restriction protrusion 56 engages with an outer peripheral portion of the second gear 45 in a state where the restriction wall portion 55 is close to the second gear 45 in the movement direction. For example, the restriction protrusion 56 engages with the second gear 45 by being fitted into a tooth groove of the second gear 45 or coming into contact with the engagement tooth 46.

The biasing portion 60 is connected to the first end portion 51 of the base portion 50. The biasing portion 60 extends upward from the base portion 50. The biasing portion 60 includes a base end portion 61 connected to the base portion 50 and a tip end portion 62 separated from the base portion 50. The biasing portion 60 extends in a U shape opened downward between the base end portion 61 and the tip end portion 62 as viewed from the main radial direction. The biasing portion 60 includes a sliding contact portion 63 that forms a part between the base end portion 61 and the tip end portion 62. The sliding contact portion 63 extends upward from the tip end portion 62. The sliding contact portion 63 directly faces the second gear 45 in the movement direction. The sliding contact portion 63 can come into sliding contact with the second gear 45 from a side opposite to the restriction wall portion 55. The biasing portion 60 biases the second gear 45 toward the restriction wall portion 55 side (the second side in the movement direction) when the sliding contact portion 63 is pressed by the second gear 45 toward the side opposite to the restriction wall portion 55. The tip end portion 62 is formed with a locking protrusion 64 protruding toward the second gear 45. The locking protrusion 64 is locked to the engagement tooth 46 of the rotating second gear 45 so as to be able to ride over the engagement tooth 46.

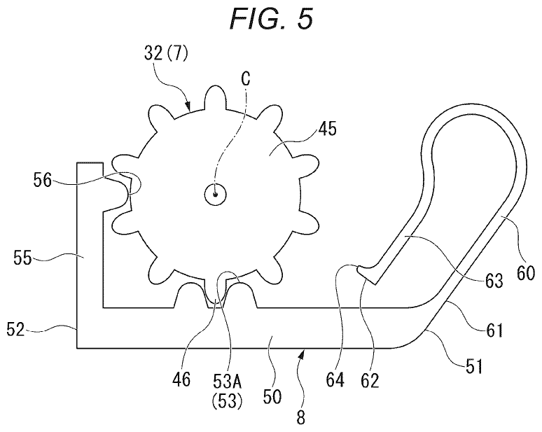

Next, operations of the timepiece 1 of the embodiment will be described with reference to FIGS. 5 to 9. FIGS. 5 to 9 are diagrams illustrating the operations of the timepiece 1 according to the embodiment and are diagrams of the rotation operation portion 7 and the rotation restriction member 8 viewed from the inner side in the axial direction.

In the timepiece 1 of the embodiment, when the rotation operation portion 7 is rotated, a torque is transmitted to the inner rotating ring 6 through the meshing between the drive teeth 41 of the first gear 40 of the drive transmission gear 32 and the tooth portions 6b of the inner rotating ring 6. In the following description, a rotation direction of the rotation operation portion 7 and the drive transmission gear 32 is a direction viewed from the inner side in the axial direction. When a counterclockwise torque is input to the rotation operation portion 7, the inner rotating ring 6 tends to rotate counterclockwise as viewed from above. When a clockwise torque is input to the rotation operation portion 7, the inner rotating ring 6 tends to rotate clockwise as viewed from above.

FIG. 5 illustrates a state where the restriction wall portion 55 is close to the second gear 45. When a counterclockwise torque is input to the rotation operation portion 7, the rotation restriction member 8 moves to the first side in the movement direction to a position where the restriction wall portion 55 is close to the second gear 45. As illustrated in FIG. 5, in the state in which the restriction wall portion 55 is close to the second gear 45, the restriction protrusion 56 is fitted into the tooth groove of the second gear 45, and the restriction wall portion 55 is engaged with the second gear 45, and counterclockwise rotation (first rotation direction) of the second gear 45 is restricted. Therefore, the counterclockwise rotation of the rotation operation portion 7 and the movement of the rotation restriction member 8 to the first side in the movement direction are restricted, and counterclockwise rotation of the inner rotating ring 6 is prevented. A position of the rotation restriction member 8 in a state where the counterclockwise rotation of the second gear 45 is restricted by the restriction wall portion 55 is referred to as a restriction position. When the rotation restriction member 8 is located at the restriction position, the clockwise rotation (second rotation direction) of the second gear 45 and the movement of the rotation restriction member 8 to the second side in the movement direction are allowed.

When a clockwise torque is input to the rotation operation portion 7 in a state where the restriction wall portion 55 is close to the second gear 45, the rotation restriction member 8 moves from the restriction position to the second side in the movement direction by the meshing between the engagement tooth 46 of the second gear 45 and the engagement portion 53 of the rotation restriction member 8 while the second gear 45 rotates clockwise. At this time, the restriction wall portion 55 is separated from the second gear 45, and the biasing portion 60 approaches the second gear 45. When the restriction wall portion 55 is separated from the second gear 45, the restriction protrusion 56 releases the engagement with the second gear 45.

FIG. 6 illustrates a state in which the biasing portion 60 is in contact with the second gear 45 in a process of the rotation restriction member 8 moving to the second side in the movement direction. As illustrated in FIG. 6, when the movement of the rotation restriction member 8 to the second side in the movement direction progresses due to the clockwise rotation of the second gear 45, the sliding contact portion 63 of the biasing portion 60 comes into contact with the second gear 45. In this state, the meshing between the second gear 45 and the engagement portion 53 is maintained. When the rotation operation portion 7 is further rotated clockwise in a state where the sliding contact portion 63 of the biasing portion 60 is in contact with the second gear 45, the second gear 45 further moves the base portion 50 of the rotation restriction member 8 to the second side in the movement direction. The second gear 45 presses the sliding contact portion 63 to the first side in the movement direction with respect to the base portion 50 while increasing the elastic deformation amount of the biasing portion 60 by moving the base portion 50 to the second side in the movement direction. At this time, since the locking protrusion 64 of the biasing portion 60 is locked to the engagement tooth 46 from a downstream side in the clockwise direction, the sliding contact portion 63 is less likely to be displaced to escape from the second gear 45, and the second gear 45 can effectively press the sliding contact portion 63. The second gear 45 is biased to the second side in the movement direction by receiving an elastic restoring force of the biasing portion 60.

The rotation restriction member 8 is biased to the first side in the movement direction by the reaction of a biasing force on the second side in the movement direction acting on the second gear 45 from the biasing portion 60. A position of the rotation restriction member 8 in a state where the biasing portion 60 biases the rotation restriction member 8 (particularly, the base portion 50) to the first side in the movement direction is referred to as a biasing position. However, the biasing position is a position of the rotation restriction member 8 corresponding to all states in which the biasing portion 60 biases the base portion 50 to the first side in the movement direction and is a region having a size in the movement direction. When the rotation operation portion 7 is rotated clockwise in a state where the rotation restriction member 8 is located at the biasing position, the rotation restriction member 8 tends to move to the second side in the movement direction by the engagement between the engagement tooth 46 of the second gear 45 and the engagement portion 53, and tends to return to the first side in the movement direction by the biasing force of the biasing portion 60.

Here, the engagement portion 53 located closest to the first side in the movement direction is referred to as an engagement/disengagement engagement portion 53A. The second gear 45 detachably engages with the engagement/disengagement engagement portion 53A in the process of rotating clockwise to press the sliding contact portion 63 to the first side in the movement direction. When the rotation operation portion 7 is continuously rotated clockwise, the engagement/disengagement engagement portion 53A rides over the engagement tooth 46 of the second gear 45 and is disengaged from the engagement tooth 46. At this time, the engagement tooth 46 over which the engagement/disengagement engagement portion 53A rides is referred to as a first engagement tooth 46A. When the engagement/disengagement engagement portion 53A rides over the first engagement tooth 46A, it is desirable that the locking protrusion 64 of the biasing portion 60 rides over the engagement tooth 46. When the engagement/disengagement engagement portion 53A is disengaged from the first engagement tooth 46A accompanying the clockwise rotation of the second gear 45, the engagement/disengagement engagement portion 53A has room for moving in a tooth groove adjacent to the first engagement tooth 46A of the second gear 45 to the first side in the movement direction.

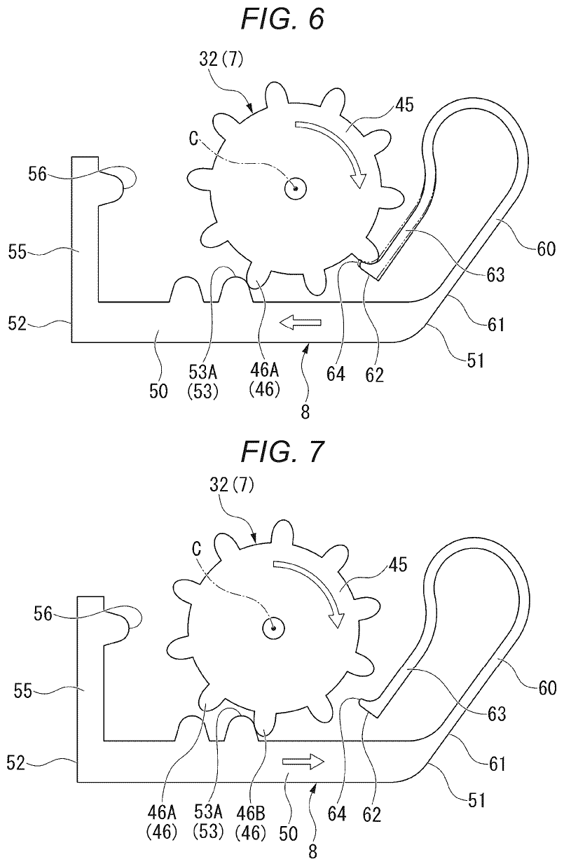

FIG. 7 illustrates a state where the engagement/disengagement engagement portion 53A collides with a second engagement tooth 46B adjacent to the first engagement tooth 46A. As illustrated in FIG. 7, since the biasing force of the biasing portion 60 acts on the base portion 50 on the first side in the movement direction, when the engagement/disengagement engagement portion 53A rides over the first engagement tooth 46A, the base portion 50 moves to the first side in the movement direction until the engagement/disengagement engagement portion 53A collides with the second engagement tooth 46B adjacent to the first engagement tooth 46A. Due to the collision between the engagement/disengagement engagement portion 53A and the second engagement tooth 46B, a counterclockwise impact is applied to the second gear 45, and a click feeling is given to the rotation operation portion 7. Then, the engagement/disengagement engagement portion 53A is detachably engaged with the second engagement tooth 46B. Therefore, by continuously rotating the rotation operation portion 7 clockwise, the rotation restriction member 8 repeats the movement to the second side and the movement to the first side in the movement direction, and the engagement and disengagement of the engagement/disengagement engagement portion 53A with respect to the engagement tooth 46 is repeated. Accordingly, since the engagement portion 53 repeatedly collides with the second gear 45 and a counterclockwise impact is applied to the second gear 45, a click feeling is periodically given to the rotation operation portion 7. In the illustrated example, the second gear 45 and the biasing portion 60 are separated from each other in a state where the engagement/disengagement engagement portion 53A collides with the second engagement tooth 46B, and the second gear 45 may come into contact with the biasing portion 60 and be biased by the biasing portion 60 in the state where the engagement/disengagement engagement portion 53A collides with the second engagement tooth 46B.

When the rotation operation portion 7 rotates clockwise, the engagement and disengagement between the second gear 45 and the engagement portion 53 are repeated, so that the rotation operation portion 7 can rotate clockwise without restriction. Therefore, when a clockwise torque is input to the rotation operation portion 7, the inner rotating ring 6 is rotated clockwise via the first gear 40.

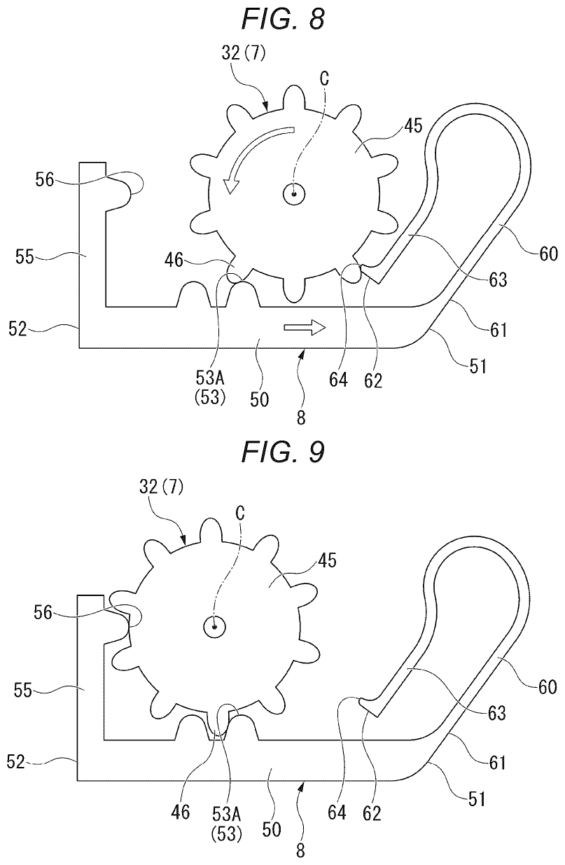

FIG. 8 illustrates a state where the rotation restriction member 8 moves from the biasing position toward the restriction position as the second gear 45 rotates counterclockwise. As illustrated in FIG. 8, when the rotation restriction member 8 is rotated counterclockwise, the rotation restriction member 8 moves to the first side in the movement direction toward the restriction position by the meshing between the engagement tooth 46 of the second gear 45 and the engagement portion 53 of the rotation restriction member 8. At this time, in the rotation restriction member 8, the biasing portion 60 is separated from the second gear 45, and the restriction wall portion 55 approaches the second gear 45.

FIG. 9 illustrates a state where the restriction wall portion 55 is closest to the second gear 45. When the restriction wall portion 55 approaches the second gear 45, the restriction protrusion 56 enters the tooth groove of the second gear 45. Accordingly, the restriction protrusion 56 is fitted into the tooth groove of the second gear 45 and restricts the counterclockwise rotation of the second gear 45. The restriction protrusion 56 may come into contact with the engagement tooth 46 of the second gear 45 to restrict the counterclockwise rotation of the second gear 45.

As described above, the timepiece 1 including the rotation operation portion 7 capable of rotating the inner rotating ring 6 only clockwise while generating a click feeling is obtained. Since the restriction wall portion 55 and the biasing portion 60 are provided at different positions in the rotation restriction member 8, it is possible to avoid concentration of a load on only one specific position in the rotation restriction member 8. Therefore, the durability of the components can be improved.

Since the biasing force of the biasing portion 60 can be adjusted by changing a shape of the biasing portion 60, it is possible to easily improve the click feeling.

The second gear 45 engages with the engagement/disengagement engagement portion 53A located at an end portion of the engagement portion 53 on the first side in the movement direction in a state where the rotation restriction member 8 is located at the biasing position. Accordingly, a configuration is obtained in which the engagement and disengagement of the engagement/disengagement engagement portion 53A with respect to the engagement tooth 46 are repeated while the rotation restriction member 8 repeats the movement to the second side and the movement to the first side in the movement direction.

The restriction wall portion 55 engages with the second gear 45 of the rotation operation portion 7. According to this configuration, since it is not necessary to provide a portion engaging with the restriction wall portion 55 in the rotation operation portion 7 other than the second gear 45, it is possible to prevent the structure of the rotation operation portion 7 from becoming complicated.

The engagement portion 53, the restriction wall portion 55, and the biasing portion 60 are located at the same position in the axial direction. With this configuration, a portion of the rotation operation portion 7 that comes into contact with the restriction wall portion 55 and the biasing portion 60 can be set to the second gear 45 that comes into contact with the engagement portion 53. Accordingly, since it is not necessary to provide a portion engaging with the restriction wall portion 55 in the rotation operation portion 7 other than the second gear 45, it is possible to prevent the structure of the rotation operation portion 7 from becoming complicated. The size of the rotation restriction member 8 in the axial direction can be reduced as compared with a configuration in which any two or more of the engagement portion 53, the restriction wall portion 55, and the biasing portion 60 are shifted from each other in the axial direction. Therefore, an increase in size of the timepiece 1 can be restricted.

The biasing portion 60 includes the locking protrusion 64 to be locked to the second gear 45 from the downstream side in the clockwise direction. With this configuration, when the second gear 45 presses the biasing portion 60 while rotating clockwise, the sliding contact portion 63 of the biasing portion 60 is less likely to be displaced so as to escape from the second gear 45. Therefore, the second gear 45 can effectively press the sliding contact portion 63.

The invention is not limited to the embodiment described above with reference to the drawings, and various modifications are conceivable within the technical scope of the invention.

For example, in the above-described embodiment, the restriction wall portion 55 restricts the counterclockwise rotation of the second gear 45 by the restriction protrusion 56 engaging with the engagement tooth 46 of the second gear 45, and the invention is not limited to this configuration. For example, the restriction wall portion may not have the restriction protrusion, and a wall surface of the restriction wall portion may come into contact with the second gear 45 in a state where the restriction wall portion is closest to the second gear 45. According to this configuration, even when a counterclockwise torque is input to the rotation operation portion 7 in a state where the second gear 45 is in contact with the restriction wall portion, since the rotation restriction member is restricted from moving to the first side in the movement direction by the contact between the second gear 45 and the restriction wall portion, the counterclockwise rotation of the second gear 45 is also restricted. Therefore, the same effects as those of the above-described embodiment can be obtained.

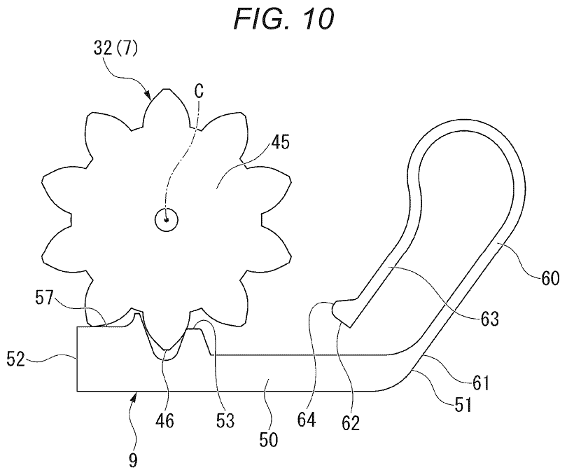

The rotation restriction member may not have a restriction wall portion that engages with the second gear 45. As illustrated in FIG. 10, a rotation restriction member 9 according to a modification of the embodiment may include a restriction protrusion 57 protruding upward from the base portion 50. The restriction protrusion 57 is configured to come into contact with the engagement tooth 46 from below in a state where the second gear 45 is engaged with the engagement portion 53. With this configuration, since the restriction protrusion 57 is engaged with the second gear 45 to restrict counterclockwise rotation of the second gear 45 and allow clockwise rotation, the same effects as those of the above-described embodiment are obtained.

The rotation restriction member may have a portion that engages with a portion of the rotation operation portion 7 other than the second gear 45, as a restriction portion that engages with the rotation operation portion 7 in a state where the rotation restriction member is located at the restriction position and that allows only rotation of the second gear 45 in one direction. For example, the restriction portion of the rotation restriction member may be configured to engage with the first gear 40.

Further, the restriction portion of the rotation restriction member may not have a portion that engages with the rotation operation portion. For example, the restriction portion of the rotation restriction member may be configured to restrict the movement of the rotation restriction member to the first side in the movement direction without engaging with the rotation operation portion. As an example, the rotation restriction member may include a restriction portion that restricts the movement of the rotation restriction member to the first side in the movement direction, which is located at the restriction position, by coming into contact with the side surface 22 facing the second side in the movement direction in the holding recess 20 of the timepiece case 2. In this case, since the movement of the rotation restriction member to the first side in the movement direction is restricted, the restriction portion can restrict the counterclockwise rotation of the second gear, and the same effects as those of the above-described embodiment are obtained.

In the above-described embodiment, the biasing portion 60 of the rotation restriction member 8 biases the second gear 45 to the second side in the movement direction and biases the base portion 50 to the first side in the movement direction by the reaction, and the invention is not limited to this configuration. For example, the biasing portion may come into contact with the side surface 22 or the like facing the first side in the movement direction in the holding recess 20 of the timepiece case 2 and be elastically deformed, thereby biasing the base portion of the rotation restriction member, which is located at the biasing position, to the first side in the movement direction.

In the above-described embodiment, the drive transmission gear 32 includes the first gear 40 and the second gear 45 provided separately from each other, and the invention is not limited to this configuration. The drive transmission gear may be a two-stage gear integrally including a first gear and a second gear. The drive transmission gear may be a single-stage gear that engages with the inner rotating ring and the engagement portion of the rotation restriction member.

In the above-described embodiment, the inner rotating ring 6 is configured to rotate only clockwise by the rotation of the rotation operation portion 7, and the invention is not limited to this configuration. That is, the inner rotating ring may be configured to rotate only counterclockwise.

In addition, the components in the above-described embodiment can be appropriately replaced with well-known components without departing from the gist of the invention, and the above-described embodiment and modifications may be appropriately combined.

What is claimed is:

1. A timepiece comprising:
a case;
a dial accommodated in the case;
an inner rotating ring formed in a ring shape along an outer peripheral edge of the dial and rotatable in a circumferential direction;
a rotation operation portion including a head portion disposed outside the case, and an engagement gear provided to be synchronously rotatable with the inner rotating ring; and
a rotation restriction member provided to be movable along a movement direction orthogonal to an axial direction of the rotation operation portion and configured to restrict an operation of the rotation operation portion, wherein
the rotation restriction member includes
an engagement portion that engages with teeth of the engagement gear so as to allow the rotation restriction member to move to a first side in the movement direction by rotation of the engagement gear in a first rotation direction and move to a second side in the movement direction by rotation of the engagement gear in a second rotation direction,
a restriction portion that restricts movement of the rotation restriction member, which is located at a restriction position, to the first side, and allows movement of the rotation restriction member to the second side, and
a biasing portion that biases the engagement portion toward the first side in a state where the rotation restriction member is moved from the restriction position toward the second side to a biasing position, and
the engagement portion is configured to be disengaged from the teeth of the engagement gear rotating in the second rotation direction in a state where the rotation restriction member is at the biasing position.

2. The timepiece according to claim 1, wherein the engagement gear engages with an end portion of the engagement portion on the first side in a state where the rotation restriction member is at the biasing position.

3. The timepiece according to claim 1, wherein the biasing portion comes into contact with the engagement gear and biases the engagement gear toward the second side in a state where the rotation restriction member is at the biasing position.

4. The timepiece according to claim 1, wherein the restriction portion restricts the movement of the rotation restriction member, which is located at the restriction position, to the first side, by engaging with the rotation operation portion.

5. The timepiece according to claim 4, wherein the restriction portion engages with the engagement gear.

6. The timepiece according to claim 5, wherein the engagement portion, the restriction portion, and the biasing portion are located at a same position in the axial direction.

7. The timepiece according to claim 1, wherein the biasing portion includes a locking protrusion that is locked to the engagement gear from a downstream side in the second rotation direction.
